(19) United States
(12) Patent Application Publication
(10) Pub. No.: US 2019/0285833 A1
(43) Pub. Date: Sep. 19, 2019

(54) OPTOELECTRONIC SENSOR AND METHOD FOR THE FOCUS ADJUSTMENT OF AN OPTICS

(71) Applicant: SICK AG, Waldkirch (DE)

(72) Inventors: Florian SCHNEIDER, Waldkirch (DE); Georg SCHÄFER, Waldkirch (DE)

(21) Appl. No.: 16/355,669

(22) Filed: Mar. 15, 2019

(30) Foreign Application Priority Data
Mar. 16, 2018 (DE) 102018106186.2

(51) Int. Cl. G02B 7/08; G06K 7/10; G01D 5/14

(52) U.S. Cl. CPC G02B 7/08; G06K 7/10831; G03B 2205/0069; G01D 5/145; G06K 7/10811

(57) ABSTRACT

An optoelectronic sensor is provided comprising a focus-adjustable optics, wherein the sensor has a movable carrier element having the optics and has a fixed-position holding element as well as a focus adjustment unit that comprises a moving coil and a magnetic unit to vary the position of the movable carrier element with respect to the holding element and thus the setting of a focal position. The moving coil is here configured as a circuit board coil.

The invention relates to an optoelectronic sensor comprising a focus-adjustable optics, wherein the sensor has a movable carrier element having the optics and has a fixed-position holding element as well as a focus adjustment unit that comprises a moving coil and a magnetic unit to vary the position of the movable carrier element with respect to the holding element and thus the setting of a focal position. The invention further relates to a method for the focus adjustment of an optics of an optoelectronic sensor, wherein a movable carrier element having the optics changes its position with respect to a fixed-position holding element in that a moving coil is controlled in whose field a magnetic unit is then moved to set a focal position.

The focusing of an optics is a task that is required for a very large group of optoelectronic sensors. This relates both to the transmission side when a light beam is to be transmitted or when a light pattern is to be projected and to the reception side for the detection of light beams or even images. A barcode scanner having a focused reading beam is used in this description as an example for a focusing at the transmission side and a camera for a focused recording of images is used as an example for a focusing at the reception side without thus excluding other optoelectronic sensors having a focus adjustment. As the example of a 3D camera with a projected illumination pattern shows, there is also a need for focusing both on the transmission side and on the reception side.

Cameras are used inter alia in industrial applications in a variety of ways to automatically detect object properties, for example for an inspection or a measurement of objects. In this respect, images of the object are recorded and are evaluated in accordance with the object by image processing methods. A further use of cameras is the reading of codes. Objects with the codes located thereon are recorded with the aid of an image sensor and the code regions are identified in the images and then decoded. Camera-based code readers also cope without problem with different code types than one-dimensional barcodes which also have a two-dimensional structure like a matrix code and provide more information. The automatic detection of the text of printed addresses, (optical character recognition, OCR) or of handwriting is also a reading of codes in principle. Despite this greater variety with camera-based readers, the specialized barcode scanners, that are as a rule less expensive with the same reading power, are still widely used. Typical areas of use of code readers are supermarket cash registers, automatic parcel identification, sorting of mail shipments, baggage handling at airports, and other logistic applications.

A frequent detection situation is the installation of a code reader or of a camera above a conveyor belt for inspection work or measurement work. The camera records images during the relative movement of the object stream on the conveyor belt and stores the detected information or instigates further processing steps in dependence on the object properties acquired. Such processing steps can comprise the further processing adapted to the specific object at a machine which acts on the conveyed objects or a change to the object stream in that specific objects are expelled from the object stream within the framework of a quality control or the object stream is sorted into a plurality of partial object streams. The objects are identified by a code reader with reference to the applied codes for a correct sorting or similar processing steps.

The focus position must be set to be able to work with different working distances and in particular to be able to read codes at different distances. There are different technologies for this. Typically, the position of the object is changed, that is the distance between the object and the image sensor, to achieve a refocusing. This movement can be driven by a stepper motor. The stepper motor, for example, generates an up and down movement via an eccentric and a pivot lever, said movement defined by the respective step position, of a transmission lens that is supported by a leaf spring. However, this is associated with very high costs and the stepper motor takes up a lot of construction space. EP 2 498 113 A1 proposes a focus adjustment for a camera-based code reader with the aid of a motor-powered cam plate and a parallel guide of the objective in a spring support that has a plurality of flat leaf springs. The disadvantages with respect to effort and/or costs and construction space are thereby not eliminated.

Moving coils are also used alternatively to a stepper motor. Their principle of action is based on the Lorentz force that is exerted by a coil through which current flows in a magnetic field. Moving coil actuators are typically suspended at thin bending beams, which produces high mechanical shock sensitivity. DE 10 2016 112 123 A1 discloses a barcode scanner having a transmission optics on a pivot arm that is pivoted for a focusing of the reading beam with a moving coil actuator. For this purpose, the moving coil is arranged on the pivot arm between standing magnets and lines thus have to be led to a moving part to apply current to the moving coil. In addition, the wound moving coil used there is again relatively expensive and large in construction.

US 2005/0185057 A1 discloses a vibration compensation for a camera. A movement detected by a vibration sensor can be compensated by a counter-movement in the X and Y directions by means of printed coils. However, this does not relate to the focus adjustment.

A camera module is known from US 2009/0252488 A1 having a movable lens for a cellular phone, wherein the movement of the lens between two magnetic units simultaneously provides the focusing and an image stabilization. One of the magnetic units can be embedded into a printed circuit board as a coil. This camera module is, however, neither provided nor suitable for industrial applications.

A guide having at least one rolled leaf spring is proposed for a focus adjustment in the still unpublished European patent application having the reference number 18155926.1. However, this document does not look at the question of how the movement is driven.

It is therefore the object of the invention to provide an improved focus adjustment.

This object is satisfied by an optoelectronic sensor having a focus-adjustable optics and by a method for the focus adjustment of an optics in accordance with the respective independent claim. The sensor comprises an optics and a focus adjustment therefor. The optics is located on a movable carrier element for this purpose. A focus adjustment unit changes the position of the movable carrier element with respect to a fixed-position holding element for a setting of a focal position. The focus adjustment unit is based on the principle of a moving coil actuator system named in the introduction and comprises a moving coil and a magnetic unit. The invention now starts from the basic idea of configuring the moving coil as a circuit board coil.

The invention has the advantage that a design is provided that is suitable for industry. The moving coil actuator system is particularly compact, in particular when the circuit board of the moving coil is simultaneously used for other purposes or if, conversely, the moving coil is integrated into an existing circuit board. A circuit board coil is also particularly simply suitable for existing device concepts. A robust, simple, and inexpensive design is produced overall.

The moving coil is preferably arranged on the fixed-position holding element and the magnetic unit on the movable carrier element. No leads to the movable carrier element, that is to the moving part of the focus adjustment unit, are then necessary.

A plurality of moving coils are preferably provided that surround the movable carrier element. The movable carrier element is therefore moved from at least two sides. A plurality of guide structures are accordingly preferably also provided. A plurality of magnetic units on the movable carrier element, each associated with a moving coil, are just as possible as magnetic elements, for example in the form of an annular magnet, that are associated with a plurality of moving coils. The moving coils are preferably synchronously controlled for a uniform and straight movement. A direct asynchronous control is also conceivable that generates additional tilts depending on the mechanical design and guidance of the movable carrier element.

The focus adjustment unit preferably has a position sensor for determining the set focal position. A focal position is admittedly theoretically already specified by the control of the moving coil, but only the determination of the actually resulting focal position produces a high precision. The actual focal position can be used for a closed loop.

The position sensor is preferably configured as a Hall sensor for determining the position of the magnetic unit. The magnetic unit thus satisfies a dual function to generate the movement and as a magnetic marker for the position sensor. A Hall sensor is particularly suitable for this and is available as a compact integrated element.

The position sensor and the moving coil are preferably arranged on the same circuit board. An even more compact arrangement is thereby achieved. A coil driver for generating the required magnetic fields in the moving coil and/or a regulation unit in which a closed loop is implemented to set the focal position with feedback of the position sensor are preferably also arranged on the same circuit board.

The moving coil is preferably configured with a conductor width differing over its winding. Such an inhomogeneous moving coil has a different conductor width at least in a partial region. Different resistances and consequently a predefinable spatial distribution of the currents and fields are thereby possible over the winding.

The moving coil preferably has a smaller conductor width in an active region in which its field acts on the magnetic unit than in the remaining winding. The different conductor widths of an inhomogeneous moving coil are thus advantageously utilized. In the active region in which the Lorentz force should be generated for a focus adjustment, the moving coil is comparatively thin, with a correspondingly high resistance and a high control force. A conductor width that is as large as possible is selected over the remaining winding since no control force is required at these locations and the total resistance of the moving coil can thus be kept smaller. A coil cross-section increased in this manner outside the magnetic field of the magnetic unit therefore permits the moving coil to be operated at higher currents and to achieve a higher actuator force. Desired secondary effects are a smaller heat development and smaller electric voltages.

The movable carrier element preferably has a frame and the fixed-position holding element has a parallel guide for the frame. The frame is in particular a rectangular frame and is guided at two oppositely disposed edges of the rectangle. The focus adjustment unit acts at at least one of these edges to move the frame on an axis perpendicular to its flat side. A film hinge is preferably used as the guide.

The flat outer side of at least one rolled leaf spring is preferably arranged between the carrier element and the holding element. This produces a simple and inexpensive guide that nevertheless brings along all the required properties. The contact between the rolled leaf spring and the holding element and carrier element is areal and not, for instance, only over an edge of the rolled leaf spring. This provides a reliable guidance and adjustment that is then also maintained. The rolled leaf spring is preferably clamped between the holding element and the carrier element. The rolled leaf spring is thus so-to-say framed by both sides and is at least a little compressed. The corresponding outer surfaces of the leaf spring contact the holding element and the carrier element. The carrier element and the holding element elastically deform the rolled leaf spring interposed between them. The carrier element and the holding element accordingly have surfaces that are directed toward one another and that are parallel with one another. It is differently also conceivable to directly vary and form the orientation and contour of the contact regions of the carrier element or holding element using the leaf spring.

The leaf spring preferably rolls on or off the surfaces during a movement of the movable carrier element. A section of the flat outer side of the leaf spring of substantially the same length remains in contact with the framing surfaces of the carrier element and of the holding element in the rolling movement during an adjustment movement of the optics on the movable carrier element. In this respect, the rolled leaf spring rotates in the course of the rolling movement and the section in contact is slightly different at every point in time in accordance with the rolling movement.

The carrier element is preferably supported linearly movably along the optical axis of the optics by means of the rolled leaf spring. A light transmitter or light receiver is preferably located in the extension of the optical axis. The linear movement then changes the distance of the light transmitter or light receiver from the optics and thus the focal position.

The rolled leaf spring preferably forms a ring. The leaf spring is rolled together and closed at its ends for this purpose. A certain overhang is conceivable as long as the required elastic properties are not thereby impaired. The term ring is initially meant topologically. The shape of the ring is more similar to an ellipse than to a circle since in the contact region to the carrier element and to the holding element, the rolled leaf spring follows the contour predefined there, and indeed over a certain peripheral region that provides sufficient stability.

The rolled leaf spring is preferably fixed to the carrier element and to the holding element. It is thus prevented that the rolled spring leaf slips relative to the carrier element or to the holding element on an adjustment of a focal position. Exactly one respective fixing point is preferably provided. This is sufficient for a fixing on the one hand and enables a movement over large adjustment paths and without unnecessary resistance on the other hand.

The guidance of the movable carrier element is advantageously improved by a plurality of leaf springs. This is particularly useful in connection with the already named embodiments in which a plurality of moving coils are provided that surround the movable carrier element.

The moving coil is preferably arranged on a flexible circuit board that is bent around the movable carrier element. The circuit board bent in this manner surrounds the carrier element at least over a certain angular range, for example of a least 90° or of at least 180°; the circuit board is preferably completely bent to form a ring. The moving coil on this circuit board is formed from one or more coil structures as a circuit board coil. A control force can thereby be exerted on the movable carrier element from a plurality of sides.

The flexible circuit board is preferably wound multiple times around the carrier element. This makes more windings of the moving coils possible, or a plurality of coil layers and thus larger control forces.

The magnetic unit preferably has a ring magnet. This is so-to-say the counter-piece to a bent circuit board with the moving coil and is preferably, but not necessarily, combined therewith. Any desired number of moving coils arranged at the periphery can exert a control force on the ring magnet. A concentric arrangement with a circuit board wound around the ring magnets or in the ring magnets enables control forces from all sides.

The sensor preferably comprises a light transmitter, with the optics being configured as a transmission optics associated with the light transmitter and/or comprises a light receiver, with the optics being configured as a reception optics associated with the light receiver. The light transmitter or the light receiver is preferably arranged on the optical axis of the optics so that a movement of the carrier element changes the distance therebetween and thus the focal position. It is also conceivable that the focal position of the sensor is adjustable both at the transmission side and at the reception side. In a coaxial arrangement of the light transmitter and the light receiver, the optics then serves as a common transmission and reception optics. In a biaxial arrangement, it is both conceivable that the light transmitter and the light receiver each have their own focus adjustments having movable carrier elements, fixed-position holding elements, and focus adjustment units, and that the transmission optics and the reception optics are located together on the same movable carrier element and a focus adjustment is only possible together.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

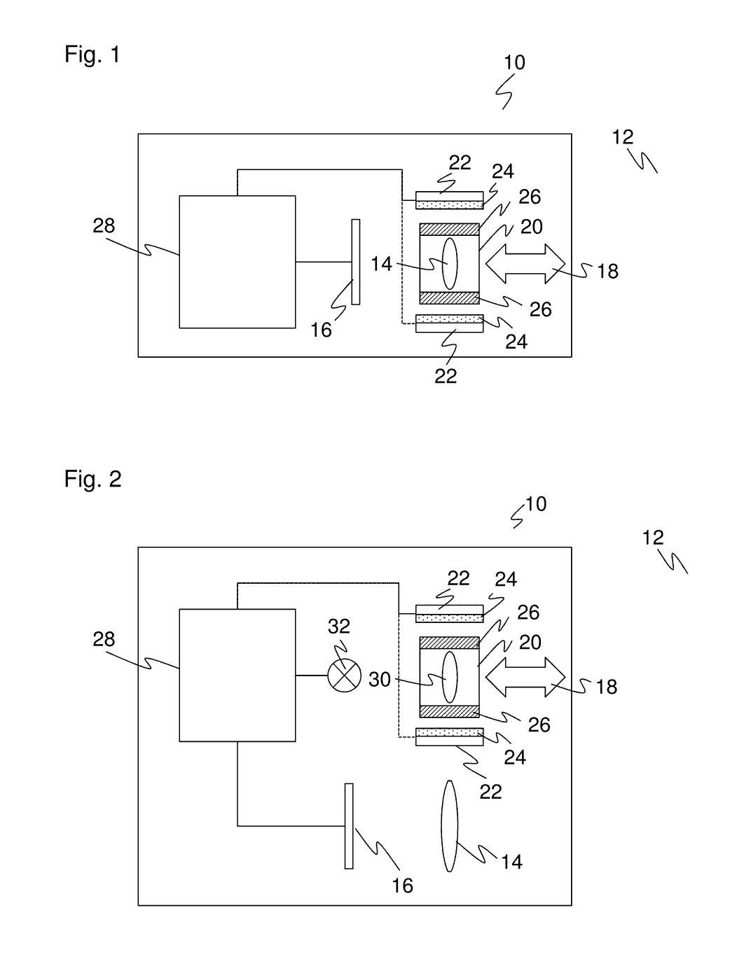

FIG. 1 a block diagram of a camera having a focus-adjustable reception optics;

FIG. 2 a block diagram of an optoelectronic sensor having a light transmitter and having a focus-adjustable transmission optics;

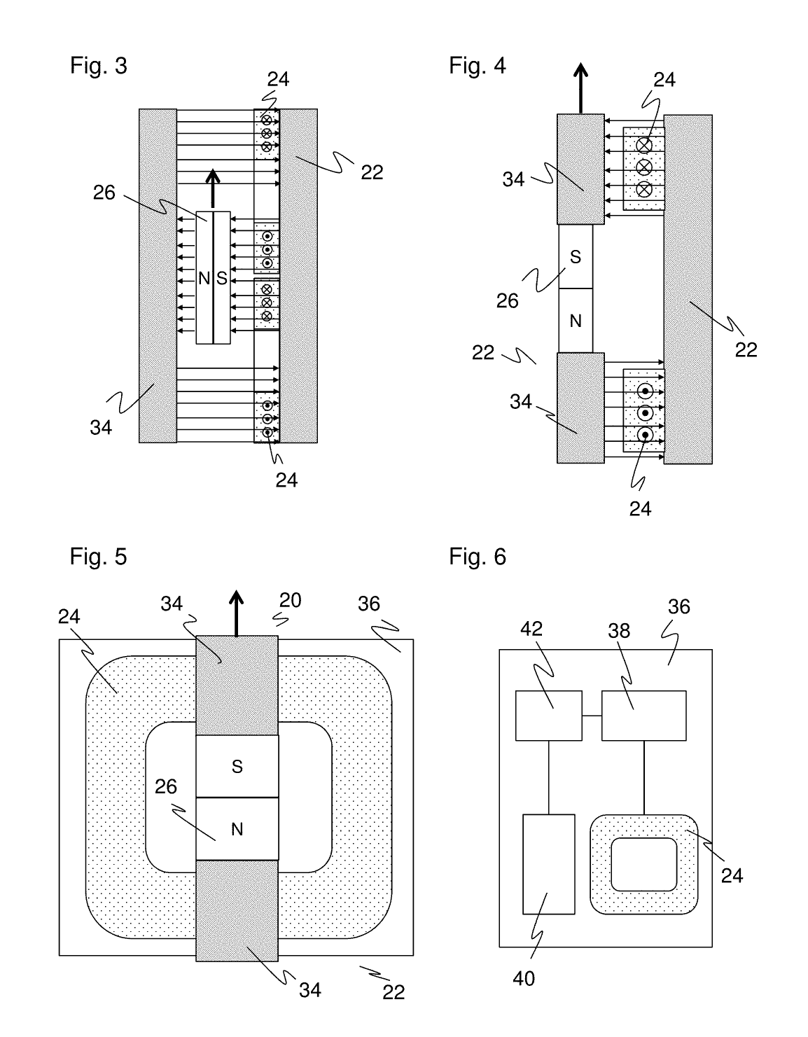

FIG. 3 a schematic sectional view of the field of a moving coil with a magnet moving therein;

FIG. 4 a schematic sectional view similar to FIG. 3, but with a magnetic flux moved along with the magnet;

FIG. 5 a frontal view of a moving coil as a circuit board coil;

FIG. 6 a block diagram of a circuit board with a moving coil, a position sensor, and a regulation;

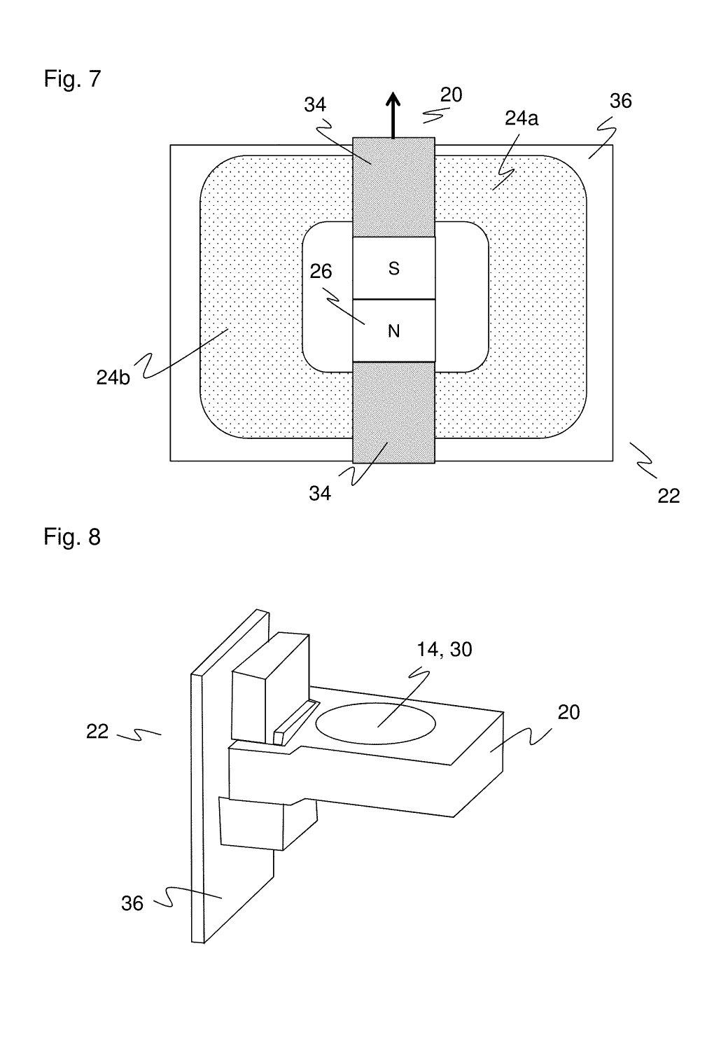

FIG. 7 a frontal view of a moving coil with regions of different line thicknesses;

FIG. 8 a schematic three-dimensional view of a parallel guide with movement through a moving coil;

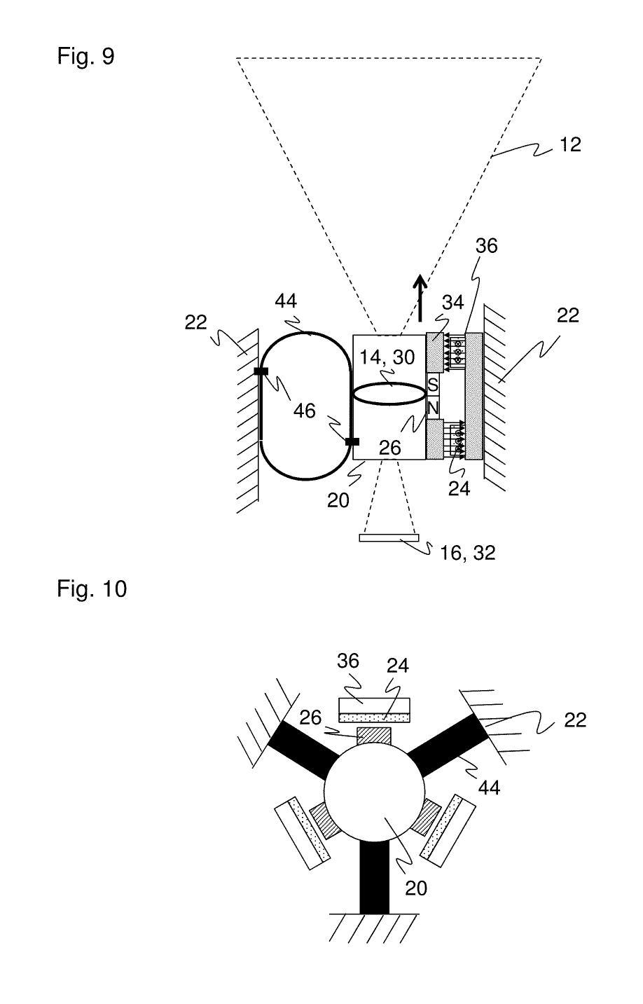

FIG. 9 a schematic view of a focus adjustment with a moving coil and guidance by a rolled leaf spring;

FIG. 10 a plan view of an arrangement in accordance with FIG. 9 with three rolled leaf springs and three moving coil actuator systems;

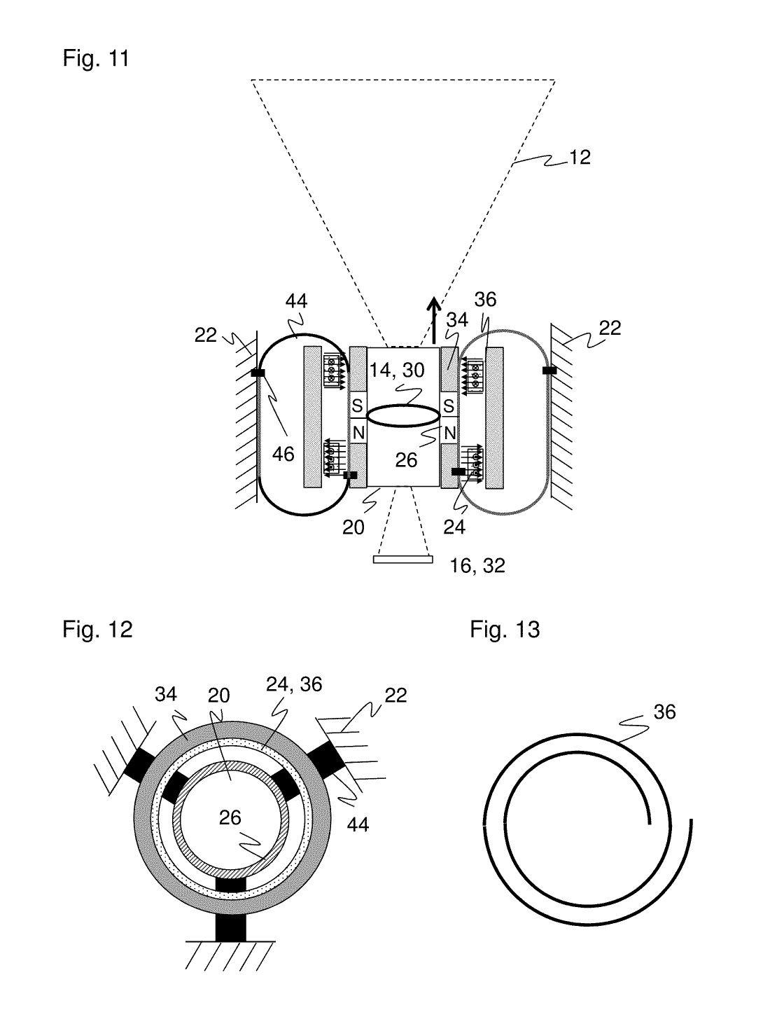

FIG. 11 a schematic view similar to FIG. 9, but with annular magnets and a bent flexible circuit board with a moving coil;

FIG. 12 a plan view of an arrangement in accordance with FIG. 11, guided by three rolled leaf springs; and

FIG. 13 a schematic view of a circuit board that is wound multiple times and that enables a multi-layer moving coil in an arrangement in accordance with FIGS. 11 and 12.

FIG. 1 shows a block diagram of a camera as an example of an optoelectronic sensor 10 having a focus adjustment at the reception side. Received light from a detection zone 12 is incident on a reception optics 14 that conducts the received light to a light receiver 16. The reception optics 14 is shown here purely by way of example with only one lens. It is generally any desired objective composed of lenses and other optical elements such as diaphragms, prisms, and the like. In the case of a camera, the light receiver 16 is an image sensor having a plurality of light reception elements in a linear arrangement or a matrix arrangement. Other sensors 10 use a photodiode, an APD (avalanche photodiode), or also a SPAD (single photon avalanche diode) receiver.

The reception optics 14 is displaceable along its optical axis on which the light receiver 16 is also arranged to adjust the focal position of the sensor 10. This is indicated by an arrow 18. For this purpose, the reception optics 14 is arranged on a movable carrier element 20 and is movable thereon with respect to a fixed-position holding element 22. The fixed-position holding element 22 is shown in two parts, which can also be understood as a section through a holding element 22 surrounding the movable carrier element 20 and is anyway purely by way of example.

The movement for focus adjustments is generated by a moving coil 24 and by a magnetic unit 26 that together form a moving coil actuator system or a focus adjustment unit. The moving coil 24 is configured in accordance with the invention as a circuit board coil, i.e. integrated in a circuit board, for example as a printed structure or any other embedded structure. The arrangement of the moving coil 24 shown on the fixed-position holding element 22 and of the magnetic unit 26 on the movable carrier element 20 is preferred because then no connector lines to a movable element are required; however, this can also be reversed. The focus adjustment as well as variations thereof will be explained more exactly below with reference to FIGS. 3 to 13.

A control and evaluation unit 28 is connected to the light receiver 16 and to the circuit board of the moving coil 24. A received signal of the light receiver 16 is read by the control and evaluation unit 28 and is stored as an image, for example, is prepared, or is examined for code regions in a camera-based code reader, with said code regions then being decoded. A respectively required focal position is set with the aid of the moving coil 24, which can also be implemented with the aid of an additional distance sensor, not shown, as an autofocus.

FIG. 2 shows a block diagram of a further embodiment of an optoelectronic sensor 10. The same reference numerals here refer to the same features or to features corresponding to one another that will not be described again. Unlike FIG. 1, a focus adjustment of a transmission optics 30 of a light transmitter 32 at the transmission side is provided here, for example having an LED or a laser as the light source. The reception optics 14 is rigid in contrast. In further embodiments, the position of the reception optics 14 having the focus adjustment can also be changed, the reception optics 14 can have a further focus adjustment, or the reception optics 14 can be configured in a coaxial design as a common optics that simultaneously acts as a transmission optics 30.

The change of the focal position by a movement of the transmission optics 30 on the carrier element 20 takes place in the same manner as in FIG. 1 to be explained in more detail with reference to FIGS. 3 to 13.

An example of an optoelectronic sensor 10 having the basic design in accordance with FIG. 2 is a barcode scanner. The light transmitter 32 generates a reading beam by means of the transmission optics 30 and said reading beam returns after reflection at an object, in particular a code region, in the detection zone 12 and is conducted via the reception optics 14 to the light receiver 16. So as not only to detect a point, but rather the whole barcode, a scan takes place by means of a scanning mechanism, not show; for example using a pivoting or rotating mirror that moves the reading beam over the code region.

It is the object of the focus adjustment in a barcode scanner to focus the reading beam sufficiently so that the code elements are resolved. The setting to a fixed or parameterized distance can be sufficient for this purpose. The current distance is, however, preferably measured. As an advantageous alternative to an additional distance sensor, its reading beam can itself be used for a distance measurement in that a frequency is imparted to the reading beam, by amplitude modulation, for example, and the distance between the time of transmission and the time of reception is determined from the phase offset in a phase process.

When scanning a barcode, the amplitude of the received signal conducted to the control and evaluation unit 28 by the light receiver 16 is modulated in a manner corresponding to the code bars. The control and evaluation unit 28 is therefore able to read the code information. It also recognizes when the received signal does not correspond to any code. The location of code regions and the reading of the code information is known per se for barcode readers and camera-based code readers and will therefore not be explained in more detail.

FIG. 3 illustrates the principle of a moving coil actuator system. The moving coil 24 is again preferably located on the fixed-position holding element 22. Since only the principle should be explained, only the magnetic unit 26 is shown and not the movable carrier element 20 that is moved by means of the magnetic unit 26. A fixed-position magnetic flux 34 is provided opposite the moving coil 24. Since the moving coil 24 is not moved, no coil feeds have to be conducted into moving elements. If the moving coil 24 has current applied, a Lorentz force thus acts on the magnetic unit 24 in the axis of the drawn arrow.

FIG. 4 shows a further embodiment of the moving coil actuator system. In contrast to FIG. 3, the magnetic flux 34 is not in a fixed position, but is rather arranged with the magnetic unit 26 on the movable carrier element 20.

FIG. 5 shows a frontal view of the moving coil 24 and of the carrier element 20 with the magnetic unit 26 and flux 34 moved thereby. The moving coil 24 is configured instead of as a conventional coil as a circuit board coil on a circuit board 36 of the fixed-position holding element 22. A coil is meant by this that is produced from line structures on a circuit board, for example a printed coil or a coil composed of corresponding metallized portions. A simple winding of corresponding conductor structures is shown purely by way of example; alternatively, any desired suitable single-part or multiple part coil structures are conceivable.

FIG. 6 shows a block diagram of the circuit board 36 in a preferred embodiment having further elements on the circuit board 36 that are arranged there together with the moving coil 24. A coil drive 38 provides a desired focus adjustment via a suitable current application to the moving coil 24. To determine the reached position of the movable carrier element 20 and thus the actual focal position, a position sensor 40 can be used, in particular a Hall sensor, that determines the position of the magnetic unit 26. A regulation unit 42 is able to readjust the focal position via the coil driver 38 in accordance with the information of the position sensor 40. Alternatively, the regulation unit 42 can also be understood as a part of the control and evaluation unit 28 or the function of the control and evaluation unit 28 and of the regulation unit 42 can be distributed over the circuit board 36 and at least one further circuit board.

FIG. 7 shows a frontal view of a further embodiment of the moving coil 24. In contrast to FIG. 5, the moving coil 24 here has an inhomogeneous conductor width. A kind of active region of the moving coil actuator system is located between the two fluxes 34. The moving coil 24 only generates the Lorentz force in the active region; the remaining coil regions are basically not relevant.

In this embodiment, the conductor track width and thus the cross-sectional surface of the moving coil 24 is therefore configured in as small a manner as possible in a part region 24a corresponding to the active region between the two fluxes 34 to obtain a force effect that is as large as possible at maximum current. Outside in a part region 34b, in contrast, the conductor track width is increased to keep the total resistance of the moving coil 24 small.

The possibility of such inhomogeneous lines is a great advantage of a moving coil 24 in circuit board technology. Conventional wound coils of insulated wire would not at all permit the coil cross-section within a winding to be varied.

FIG. 8 shows an embodiment in which the movable carrier element 20 is configured as a rectangular frame. The circuit board 36 on which the moving coil 24 is arranged, without a separate representation, to act on the magnetic unit 26 on the carrier element 20, or also further components as in FIG. 6, is located at at least one side. The carrier element 20 moves in a parallel guide that is implemented, for example, via a film hinge guide. A corresponding further circuit board 36 or a passive further guide can be provided on the oppositely disposed side.

Such a parallel guide is particularly suitable in the reception path of a camera and is only an example. Alternatively, a pivot lever is also conceivable as the moving carrier element 20 as in DE 10 2016 112 123 A1 named in the introduction, but with the moving coil 24 preferably not being arranged on the pivot lever as there, but rather in a fixed position. Such a pivot lever solution is, for example, suitable for barcode scanners. Different carrier elements 20 moved by a moving coil 24 in different guides are also possible.

FIG. 9 illustrates an advantageous further guide by means of a rolled leaf spring 44. FIG. 9 shows a sectional representation with only one rolled leaf spring 44. This is admittedly not precluded, but a plurality of leaf springs 44 and also a plurality of moving coil actuator systems are preferably arranged around the movable carrier element 20 for a force distribution that is as uniform as possible. FIG. 10 shows an optics 14, 30 located at the center on the movable carrier element 20 in a plan view, said optics 14, 30 being driven by three actuators or moving coils 24, for example, and being held and guided by three rolled leaf springs 44. In this respect, all the moving coils 24 are operated synchronously for a uniform linear movement. Alternatively, a non-synchronous operation is also possible to directly incline the optics 14, 30, for instance for image stabilization. The rolled leaf springs 44 only allow limited freedom for an inclination and can, if desired, be replaced with a guide having more degrees of freedom as with thin bending beams.

The functional principle of the guide with rolled leaf springs 44 will be explained in a little more detail with reference to FIG. 9. The rolled leaf springs 44 are fastened to the movable carrier element 20 and to the fixed-position holding element 22 with a respective fixing point 46. The fixing is also conceivable at additional points, but this shortens the possible adjustment path; or it can conversely also be omitted since the rolled leaf springs 44 are clamped by their spring force and the roll friction is smaller than the static friction.

A force effect on the movable carrier element 20 in the direction of the longitudinal axis effects a rolling on or off the rolled leaf springs 44. The rolled leaf springs 44 form a ring that can be seen in cross-section. The ring is elongated by the clamping between the carrier element 20 and the holding element 22, but still deviates from an ellipse since the lateral regions of the rolled leaf springs 44 approximate to the respective contour of the contact surfaces with the carrier element 20 and the holding element 22. The rolled leaf springs 44 can only be seen as a line due to the cross-sectional representation. In fact, the ring has an areal extent in the direction perpendicular to the plane of the paper, corresponding to the nature of a leaf spring. The corresponding lateral outer surfaces are pressed toward the carrier element 20 and the holding element 22 by the spring force. Due to the rolling movement, the same length of the rolled leaf springs 44 laterally contact the carrier element 20 and the holding element 22 in all the adjustment positions. The large contact surface effects a stabilization of the adjustment movements and of the set focal positions. The displacement can be influenced via the length of the contacting portion of the rolled leaf springs 44.

FIGS. 11 and 12 show in a sectional view or a plan view a further embodiment having a ring arrangement that replaces the three separate moving coils 24 in accordance with FIG. 10 with a symmetrical design. Rolled leaf springs 44 are again used as the guide, but the ring arrangement does not necessarily require this kind of guidance, but can also be combined with a different guide.

The circuit board 36 in this embodiment is a flexible circuit board that is bent to form a ring. The circuit board 36 is placed into a surrounding annular magnetic flux 34. The circuit board 36 and the flux 34 are here part of the fixed-position holding element 22. The magnetic element 26 configured as a ring magnet, preferably likewise with a flux not shown separately, is located at the center. The moving coil 24 on the circuit board 36 can be formed from one piece or in a plurality of segments. The upper and lower lines of the moving coil flowed through by current are connected to one another at one or more points. The moving coil 34 preferably uses the annular circuit board 36 so that the moving coil 24 and the ring magnet of the magnetic unit 26 are opposite via 360°. Alternatively, however, discrete moving coil regions are also conceivable, which is then an alternative implementation of the arrangement in accordance with FIG. 10. The ring magnet can in another respect also be combined with separate moving coils 24 as in FIG. 10 or conversely a bent flexible circuit board 36 with separate magnetic units 26 not formed as a ring magnet. A reversal of the shown arrangement is also possible in which the moving coil 24 is located on a flexible circuit board 36 of the movable carrier element and the ring magnet of the magnetic unit 26 is part of the fixed-position holding element 20.

FIG. 13 shows a flexible circuit board 36 wound multiple times to form a spiral in a sketch-like manner. A multilayer moving coil 24 with an increased number of windings can be achieved in this manner. It would conversely be conceivable to bend the flexible circuit board 36 not fully to form a ring, but rather only to cover a certain angular range of less than 360° by it.

1. An optoelectronic sensor comprising a focus-adjustable optics, wherein the sensor has a movable carrier element having the optics and has a fixed-position holding element as well as a focus adjustment unit that comprises a moving coil and a magnetic unit to vary a position of the movable carrier element with respect to the holding element and thus a setting of a focal position, wherein the moving coil is configured as a circuit board coil.

2. The optoelectronic sensor in accordance with claim 1,
wherein the moving coil is arranged on the fixed-position holding element and the magnetic unit is arranged on the movable carrier element.

3. The optoelectronic sensor in accordance with claim 2,
wherein a plurality of moving coils are provided that surround the movable carrier element.

4. The optoelectronic sensor in accordance with claim 1,
wherein the focus adjustment unit has a position sensor for determining the set focal position.

5. The optoelectronic sensor in accordance with claim 4,
wherein the position sensor is configured as a Hall sensor for determining the position of the magnetic unit.

6. The optoelectronic optoelectronic sensor in accordance with claim 4, further comprising a circuit board, wherein the position sensor and the moving coil are both arranged on the circuit board.

7. The optoelectronic sensor in accordance with claim 1,
wherein the moving coil is formed with a conductor width differing over its winding.

8. The optoelectronic sensor in accordance with claim 7,
wherein the moving coil has a smaller conductor width in an active region in which its field acts on the magnet unit than in the remaining winding.

9. The optoelectronic sensor in accordance with claim 1,
wherein the movable carrier element has a frame and the fixed-position holding element has a parallel guide for the frame.

10. The optoelectronic sensor in accordance with claim 1,
wherein the flat outer side of at least one rolled leaf spring is arranged between the carrier element and the holding element so that said rolled leaf spring rolls on or off during a movement of the movable carrier element.

11. The optoelectronic sensor in accordance with claim 1,
wherein the moving coil is arranged on a flexible circuit board that is bent around the movable carrier element.

12. The optoelectronic sensor in accordance with claim 11,
wherein the flexible circuit board is wound a multiple times around the carrier element.

13. The optoelectronic sensor in accordance with claim 1,
wherein the magnetic unit has a ring magnet.

14. The optoelectronic sensor in accordance with claim 1,
that comprises a light transmitter, wherein the optics is configured as a transmission optics associated with the light transmitter; and/or that comprises a light receiver, wherein the optics is configured as a reception optics associated with the light receiver.

15. A method for the focus adjustment of an optics of an optoelectronic sensor, wherein a movable carrier element having the optics changes its position with respect to a fixed-position holding element in that a moving coil is controlled in whose field a magnetic unit is then moved to set a focal position, wherein a moving coil is controlled that is configured as a circuit board coil.
